(19) United States
(12) Patent Application Publication
(10) Pub. No.: US 2004/0005912 A1
(43) Pub. Date: Jan. 8, 2004

(54) Method of locking a mobile telecommunications terminal

(75) Inventors: Pascal Hubbe, Paris (FR); Francis Sykes, Paris (FR)

Correspondence Address: SUGHRUE MION, PLLC, Suite 800, 2100 Pennsylvania Avenue, N.W., Washington, DC, 20073-3213, US

(73) Assignee: ALCATEL

(21) Appl. No.: 10/610,706

(22) Filed: Jul. 2, 2003

(30) Foreign Application Priority Data
Jul. 4, 2002 (FR) 02 08 372

(51) Int. Cl. H04M 1/00

(52) U.S. Cl. 455/558; 455/575.9

(57) ABSTRACT

The present invention provides a method of locking a mobile terminal for a telecommunications network. According to the invention, the terminal implements the following operations:

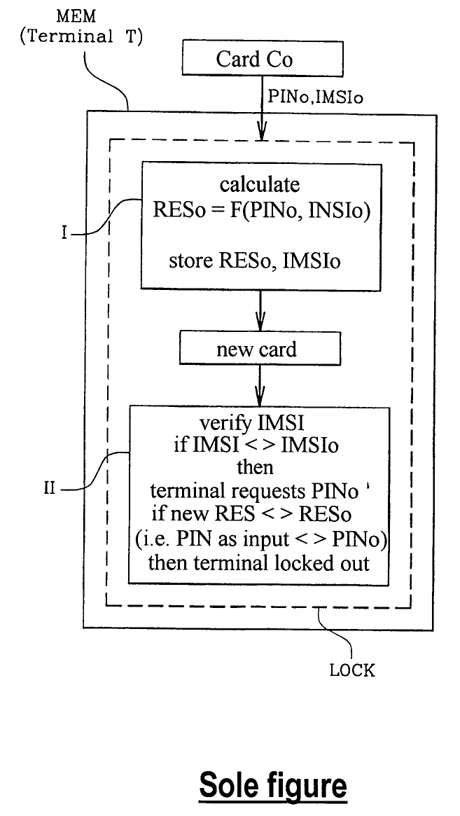

calculating a code on the basis of input data comprising at least a unique subscriber identity (IMSI₀) of a first subscriber card of the (U)SIM type, and a personal identification number (PIN₀) of the user of said first card;

detecting whether a new card has been inserted, and if so asking the user for the personal identification number (PIN₀) of the first card in order to verify whether it matches the stored information; and

locking out operation of the terminal in the event of a mismatch.

The invention is applicable to protecting mobile terminals against theft.

The present invention relates to a method of locking a mobile telecommunications terminal. It also relates to a mobile terminal including means for implementing the locking method.

The outstanding success of mobile telephones means that they are now part of our daily environment, and the total number of mobile telephones in the world amounts to hundreds of millions. As general rule, such telecommunications terminals or mobile telephones include a smart card commonly referred to as a subscriber identity module or (U)SIM card.

A (U)SIM contains information that the user cannot alter serving to identify the user and to identify the subscriber, for example the integrated circuit card identity number (ICCid) and the subscriber number for calling the mobile telephone, known as the international mobile subscriber identity (IMSI).

The (U)SIM card is issued when a subscriber acquires a mobile telephone. The card is put into place in the mobile telephone and makes it operational as soon as the user enters a personal identification number (PIN) from the telephone keypad.

The PIN code is stored in secure manner by the card and is known only to the user. Each time the telephone is switched on, the card asks the user to input the PIN code and the card certifies the code that is input.

In its memory, the (U)SIM card includes a communications program that corresponds to the protocol for communication with mobile telephone terminals in application of the standards GSM TS11-11 and 3GPP (TS 31.101).

The (U)SIM card also has a program memory containing one or more application programs, with the telephony application no longer being the only application provided, since other applications such as electronic purchasing are available.

Consequently, the mobile terminal of a subscriber A₀ is fitted with a smart card reader enabling it to communicate with the (U)SIM card C₀. The reader has a man-machine interface for enabling exchanges to take place between the user and the card via the terminal. For this purpose, the user has a menu made available which scrolls on the screen of the terminal, and also has available the terminal keypad.

The terminal is also fitted with other electronic circuits which need not be described in detail in order to understand the description below, such as means for storing programs and data and means for communicating with one or more telecommunications networks.

The problem that arises is explained below.

The increasing mobile telephone market has given rise to a growing parallel or black market of stolen mobile telephones.

A thief who takes the telephone from another person can use the telephone if it was active when taken and until the battery runs down. After that the thief can no longer use the telephone without knowing the proprietor's PIN code. However, it is unfortunately entirely possible for the thief to install another (U)SIM card. Thus, an old telephone can be upgraded by stealing a telephone of more recent technology. A market therefore exists in stolen telephones since it enables people acquiring such telephones to take a SIM card from an old model of telephone and put it into the new model (stolen or purchased from a thief), or indeed to install in a stolen telephone a smart card that corresponds to a different subscription.

This market is possible so long as it is possible to use a telephone with a SIM card other than its initial card, in order words with a different subscription.

A known solution to this problem is to lock the operation of the mobile telephone to the (U)SIM card with which it was delivered in the context of a combined purchase comprising both a subscription and an appliance, i.e. a “pack”. That mechanism is defined by the European Telecommunications Standards Institute (ETSI) and is known as SIM Lock. It protects the operator against a telephone being used with a subscription taken out with another operator. That solution is managed by the telecommunications operator for a limited duration. Since the market is now mature, consumers are purchasing recent terminals for use with a subscription (SIM) that they already have. In practice, a subscriber who has just had a telephone stolen calls the telecommunications operator to report the theft and the operator locks out use of the (U)SIM card. That solution protects the subscriber against use of the subscriber's subscription (in addition to the protection provided so long as the PIN code remains undiscovered), and spares the operator disputes concerning refusals to pay.

However that solution does not serve to solve the problem of theft since a stolen telephone can still be used.

An object of the present invention is to remedy that situation.

The solution proposed relies on the terminal being locked by the terminal itself after it has detected that a card inserted in the terminal does not correspond to the initial subscription card.

The present invention thus provides a method of locking a mobile terminal for a telecommunications network, the terminal including a smart card reader serving in particular to identify a subscriber, said card being of the (U)SIM card type including at least one non-modifiable unique subscriber identity (e.g. IMSI), and the method being mainly characterized by the fact that it comprises the following operations performed by the terminal:

calculating a code based on the following input data at least a unique subscriber identity (IMSI) of a first (U)SIM type subscriber card, and a personal identification number of the user of said first card;

detecting whether a new card has been inserted and, if so, asking the user to input the personal identification number of the first (U)SIM type card in order to verify whether it matches the information that has been stored; and

locking out operation of the terminal if the information does not match.

In one variant implementation, the unique subscriber identity is the international mobile subscriber identifier (ISMI).

In another variant, the unique subscriber identity is the integrated circuit card identity number (ICCid).

According to another characteristic, the code is calculated by means of an injective function such as a cryptographic algorithm of the data encryption standard (DES) or 3DES type, or a hash function.

The invention also provides a mobile telecommunications terminal mainly characterized in that it includes a non-volatile memory containing a program suitable for implementing the above-described method.

Other features and advantages of the invention appear clearly on reading the following description which is given by way of non-limiting example and with reference to the sole figure which shows the method implemented by a program LOCK loaded in the terminal.

The program LOCK for implementing the method of the invention is stored in a program memory MEM of the terminal T. The corresponding “Lock” function is made available to the user who can activate it if so desired. For this purpose, the “Lock” function appears in the menu which is displayed on the screen of the terminal.

The program has a first step I implemented on the first occasion that a (U)SIM C₀ is inserted.

This step comprises calculating the code RES such that RES=F(PIN₀, IMSI₀) . The function F is an injective cryptographic function, i.e. F⁻¹(RES)=(PIN₀, IMSI₀) or else a function that makes it possible to confirm that the PIN code used is the correct code.

The personal identification number PIN₀ and the international mobile subscriber identifier IMSI₀ are the input data for the calculation performed by the program in this example.

The number IMSI₀ is merely an example, and it could be replaced by any other unique and non-modifiable characteristic of the card. For example, it is possible to use the integrated circuit card identification number (ICCid).

This step I also includes storing the code RES that is obtained and the number IMSI₀.

Thereafter, each time a new SIM card is inserted, as illustrated by step II, the program verifies the IMSI number by comparing it with the number already stored:

if this number (IMSI) is different, then the program requests the personal identification number PIN₀ of the first card and checks on the basis of the stored data whether the correct PIN code has been input;

if this number (PIN code) is different, then the terminal locks out its own operation, otherwise it continues to function.

This disposition thus prevents a terminal being used until the personal identification number code PIN₀ of the first (U)SIM card is input by the user.

The function F is an injective function (i.e. F⁻¹(RES)=(PIN₀, IMSI₀)), but it could equally well be a hash function, or a cryptographic algorithm such as the DES or the 3DES algorithm.

It is the terminal which contains in one of its non-volatile memories the program for implementing the steps described above to perform the locking function. It is thus advantageously the terminal which asks the user to input the user's own PIN code. This step consequently remains independent of the conventional mechanism for inputting the PIN code which is performed at the request of the (U)SIM card when the terminal is switched on.

What is claimed is:

1/ A method of locking a mobile terminal for a telecommunications network, the terminal including a reader for reading a subscriber identification card of the SIM card type that includes at least one unique subscriber identity (IMSI), the method being mainly characterized in that it comprises the terminal performing the following operations:
calculating a code on the basis of input data comprising at least a unique subscriber identity (IMSI₀) of a first subscriber card of the (U)SIM type, and a personal identification number (PIN₀) of the user of said first card;
detecting whether a new card has been inserted, and if so asking the user for the personal identification number (PIN₀) of the first card in order to verify whether it matches the stored information; and
locking out operation of the terminal in the event of a mismatch.

2/ A method of locking a mobile terminal for a telecommunications network according to claim 1, characterized in that a unique subscriber identity is the international mobile subscriber identity (IMSI).

3/ A method of locking a mobile terminal for a telecommunications network according to claim 1, characterized in that a unique subscriber identity is the integrated circuit card identity number (ICCid).

4/ A method of locking a mobile terminal for a telecommunications network according to claim 2, characterized in a unique subscriber identity is the integrated circuit card identity number (ICCid).

5/ A method of locking a mobile terminal for a telecommunications network according to claim 1, characterized in that the code is calculated by means of an injective function such as a cryptographic algorithm of the DES or 3DES algorithm type, or by means of a hash function.

6/ A method of locking a mobile terminal for a telecommunications network according to claim 2, characterized in that the code is calculated by means of an injective function such as a cryptographic algorithm of the DES or 3DES algorithm type, or by means of a hash function.

7/ A method of locking a mobile terminal for a telecommunications network according to claim 3, characterized in that the code is calculated by means of an injective function such as a cryptographic algorithm of the DES or 3DES algorithm type, or by means of a hash function.

8/ A method of locking a mobile terminal for a telecommunications network according to claim 4, characterized in that the code is calculated by means of an injective function such as a cryptographic algorithm of the DES or 3DES algorithm type, or by means of a hash function.

9/ A mobile telecommunications terminal, characterized in that it includes a non-volatile memory containing a program suitable for implementing the method according to claim 1.

10/ A mobile telecommunications terminal, characterized in that it includes a non-volatile memory containing a program suitable for implementing the method according to claim 2.

11/ A mobile telecommunications terminal, characterized in that it includes a non-volatile memory containing a program suitable for implementing the method according to claim 3.

12/ A mobile telecommunications terminal, characterized in that it includes a non-volatile memory containing a program suitable for implementing the method according to claim 4.

13/ A mobile telecommunications terminal, characterized in that it includes a non-volatile memory containing a program suitable for implementing the method according to claim 5.

14/ A mobile telecommunications terminal, characterized in that it includes a non-volatile memory containing a program suitable for implementing the method according to claim 6.

15/ A mobile telecommunications terminal, characterized in that it includes a non-volatile memory containing a program suitable for implementing the method according to claim 7.

16/ A mobile telecommunications terminal, characterized in that it includes a non-volatile memory containing a program suitable for implementing the method according to claim 8.
